(19) United States
(12) Patent Application Publication
(10) Pub. No.: US 2006/0017944 A1
(43) Pub. Date: Jan. 26, 2006

(54) Image forming apparatus

(75) Inventors: Manabu Nakahanada, Tokyo (JP); Takashi Deguchi, Tokyo (JP); Atsushi Suzuki, Tokyo (JP); Noriaki Matsubara, Osaka (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/189,351

(22) Filed: Jul. 25, 2005

(30) Foreign Application Priority Data
Jul. 26, 2004 (JP) 2004-217585

(51) Int. Cl. G06K 15/10

(52) U.S. Cl. 358/1.8

(57) ABSTRACT

An image forming apparatus including a recording head constituted by arraying a plurality of recording elements, in which relative movement is caused between the recording head and a recording material to perform recording in the recording material, the apparatus includes: a first drive control member which drives the recording elements before recording in the recording material is started, and a second drive control member which drives the recording elements, on the basis of an input signal value which is used to drive the recording head after an original image is converted by such as image processing and a drive of the recording head, in order to perform recording in the recording material, wherein the second drive control member drives the recording elements such that recording in a predetermined low record amount is performed in a predetermined low record amount area.

### BACKGROUND OF THE INVENTION

1. Field of the Invention

The present invention relates to an image forming apparatus for performing recording in recording materials.

2. Description of Related Art

In recent years, along with the popularization of digital cameras, a digital mini-laboratory system as a digital output device is strongly desired to be improved in performances such as printing ability or image quality. Particularly, a large-sized print is strongly required. In response to the request, many developments of exposure engines suitable for the print are made using a print head constituted by arraying a plurality of recording elements, and are reported in earlier studies.

It is commonly known that the array-like print head described above has the following problem. That is, the heating value generated in each recording element differs depending on operating conditions of the print head, more specifically, depending on driving histories of a plurality of the recording elements constituting the print head. Due to the difference of the heating values, the whole light emission amount changes.

As a factor of reduction in the heating value, gases adsorbed onto an element reduced in a drive time are cited. In order to find out the factor, there are known a method of driving a recording element for a predetermined time to make a heating value constant without contributing to image formation of the recording element (see, e.g., J P Tokuganhei 09-174887); a method of previously performing preliminary light emission before starting image recording in silver halide photographic sensitive materials (see, e.g., J P Application Publication-Tokuganhei-10-324020); and a method of driving a recording head during non-recording to keep luminance of a recording head during actual recording to a certain range (see, e.g., J P Tokugan-2002-113901).

The methods described in the above three references are those dissolving the above-described problem by driving recording elements before starting recording or by driving recording elements at regular time intervals after application of power to an apparatus. Therefore, these methods are effective in reducing image density changes among respective recorded images (print).

However, the problem of the image density changes occurs also in a sheet of print because the changes are dependent on driving histories of the printing elements.

Concretely, for example, the following problem occurs. When recording an image comprising a leading part where many image areas recorded in a relatively low record amount are present, the light emission amount of the recording elements once having a light emission amount in a certain range by a preliminary light emission before starting recording (in a non-recording area) decreases during recording of the low record amount area.

Thereafter, when an effect of the preliminary light emission largely decreases already at a stage of performing recording of a high density area adjacent to the low record amount area, a desired image density cannot be reproduced for a while after starting recording of an image of the high density area adjacent to an image of the low record amount area.

Further, also the following problem occurs. When the density change occurs only in a specific recording element, the image density, namely, input-output characteristics (gradation characteristics) change in a sheet of the print. Since the change of the gradation characteristics is affected by driving conditions of each recording element, namely, by light emission amount histories thereof, generation of density irregularity changing in a sub-scanning direction is caused with the passage of the recording time.

Further, when studying recording characteristic correction of each recording element performed for the sake of making uniform the record amount of each recording element constituting a recording head, the above-described problem particularly becomes important. This is because in the case of performing the recording characteristic correction by using, for example, an image in which the density change occurs due to the driving histories of the recording elements, since the correction is not made using an appropriate image, variation in the record amount of the recording element subjected to the recording characteristic correction is reflected on all the prints, and as a result, there arises a problem that the prints are not put into practical use as commodities.

Further, JP HEI-09-174887A describes an invention where a recording element of which the image output is to be zero is driven by an output smaller than that contributing to the image output. However, since the output contributing to the image output is different due to material characteristics of recording materials, the invention has no configuration applicable to arbitrary recording materials.

### SUMMARY OF THE INVENTION

In view of the foregoing, it is an object of the present invention to provide an image forming apparatus capable of suppressing image density changes so as to prevent degradation of image quality even when the low density image area covers a wide range in a sheet of printed image (print). According to the present invention, it becomes possible to actuate the recording element whose image output should be zero, according to property of the recording material, even when the material property of the recording materials are significantly different each other.

In order to attain the above object, according to a first aspect of the invention, an image forming apparatus comprising a recording head constituted by arraying a plurality of recording elements, in which relative movement is caused between the recording head and a recording material to perform recording in the recording material, the apparatus comprises:

a first drive control member which drives the recording elements before recording in the recording material is started, and

a second drive control member which drives the recording elements, on the basis of an input signal value which is used to drive the recording head after an original image is converted by such as image processing and a drive of the recording head, in order to perform recording in the recording material,

wherein the second drive control member drives the recording elements such that recording in a predetermined low record amount is performed in a predetermined low record amount area.

Thus, the first preliminary drive controlling member drives each recording element constituting a recording head and then starts actual recording. The second preliminary drive controlling member allows the recording element to continue to keep a drive state on the basis of the input signal value even after starting recording.

Since the first preliminary drive controlling member drives the recording element (hereinafter, referred to as “preliminary light emission”) before starting recording, variation in drive history of each recording element, namely, variation in the record amount of each recording element is suppressed. As a result, change of the image density can be reduced so as to prevent degradation of the image quality.

Further, since the second preliminary drive controlling member drives the recording element even after starting the recording (hereinafter, referred to as “fine light emission”), an effect of the preliminary light emission can be maintained. As a result, even when a low density image area covers a wide range in a sheet of the printed image (print), in other words, even when the effect of the preliminary light emission is lost, the change of the image density can be suppressed so as to prevent the degradation of the image quality.

Preferably, the second drive control member drives the recording elements by using a lookup table where the input signal value which is used to drive the recording head after an original image is converted by such as image processing and an output signal value inputted to the recording head are correlated with each other.

As described above, since the recording element is driven by using a look-up table (hereinafter, referred to as a “LUT”) where the input signal value and the output signal value are correlated, an output value appropriate to an input value is obtained without performing complicated controls. As a result, the drive of the recording elements is readily and surely controlled so as to suppress the change of the image density.

Preferably, the predetermined low record amount area is an area comprising an input signal value S set on the basis of an input signal value SO capable of obtaining a reference density, the input signal value S satisfying an expression of log(S/S₀)≦−1.0 in a characteristic curve of the recording material.

Based on this, the input signal value S in a sufficiently low range as compared with an arbitrary input signal value So capable of obtaining the reference density can be set with suppression of an adverse effect on recording materials.

As a result, in an arbitrary recording material, the effect of the preliminary light emission can be maintained without any restriction on the input signal value S₀ (namely, material characteristic of the recording materials) of the recording material, in other words, without any effect on an actual image so as to prevent degradation of the image quality.

Preferably, the second drive control member controls drive of the recording elements such that the predetermined low record amount is a constant value in the predetermined low record amount area.

As described above, since recording in the predetermined low record amount is performed with a constant value in a predetermined low record amount area, an effect of the low record amount is maintained as well as excessive recording is prevented. As a result, the change of the image density can be effectively suppressed so as to prevent the degradation of the image quality.

Preferably, the second drive control member drives the recording elements such that the recording in the predetermined low record amount is always performed in the predetermined low record amount area, when the recording element drives during an image formation.

Also in the predetermined low record amount area, particularly also in the image where predetermined low record amount areas liable to lose an effect of the preliminary light emission are continuously present, since the drive of the recording element is always performed, reduction in the record amount of the recording element for recording the image of the low record amount area can be prevented. As a result, the change of the image density can be more surely suppressed regardless of the image density.

### BRIEF DESCRIPTION OF THE DRAWINGS

FIG. 1 is a schematic construction diagram of an image forming apparatus 1 according to a first embodiment of the present invention;

FIG. 2 is a diagram showing characteristics of a recording material;

FIG. 3 is a diagram for illustrating a drive voltage;

FIG. 4 is a perspective diagram of an optical shutter chip 412;

FIG. 5 is a diagram showing characteristics of a recording material;

FIG. 6 is a flow chart showing one example of drive of a PLZT element;

FIG. 7 is a schematic construction diagram of an image forming apparatus 100 according to a second embodiment of the present invention;

FIG. 8 is a diagram showing a transmission distribution of a PLZT element in each of light source colors R, G and B;

FIG. 9 is a diagram showing a change of a light transmission amount relative to a change of a drive voltage;

FIG. 10 is a diagram for illustrating a method of determining an optimal voltage (Vd);

FIG. 11 is a diagram showing a construction of a correction image;

FIG. 12 is a diagram showing a construction of a correction image;

FIG. 13 is a flow chart showing one example of drive of a PLZT element;

FIG. 14 is a flow chart showing correction processing by an image forming apparatus 100;

FIG. 15 is a diagram showing a conversion line of a sensitive material;

FIG. 16 is a diagram for illustrating a method of determining a conversion line of a sensitive material; and

FIG. 17 is a diagram for illustrating a sensitivity change in a characteristic curve.

### DETAILED DESCRIPTION OF THE INVENTION

### First Embodiment

A first embodiment of the present invention is described in detail below by referring to the drawings. However, the scope of the present invention is not limited to the examples shown in figures. Further, a limited expression is used in some cases; however, the present invention is not limited thereto.

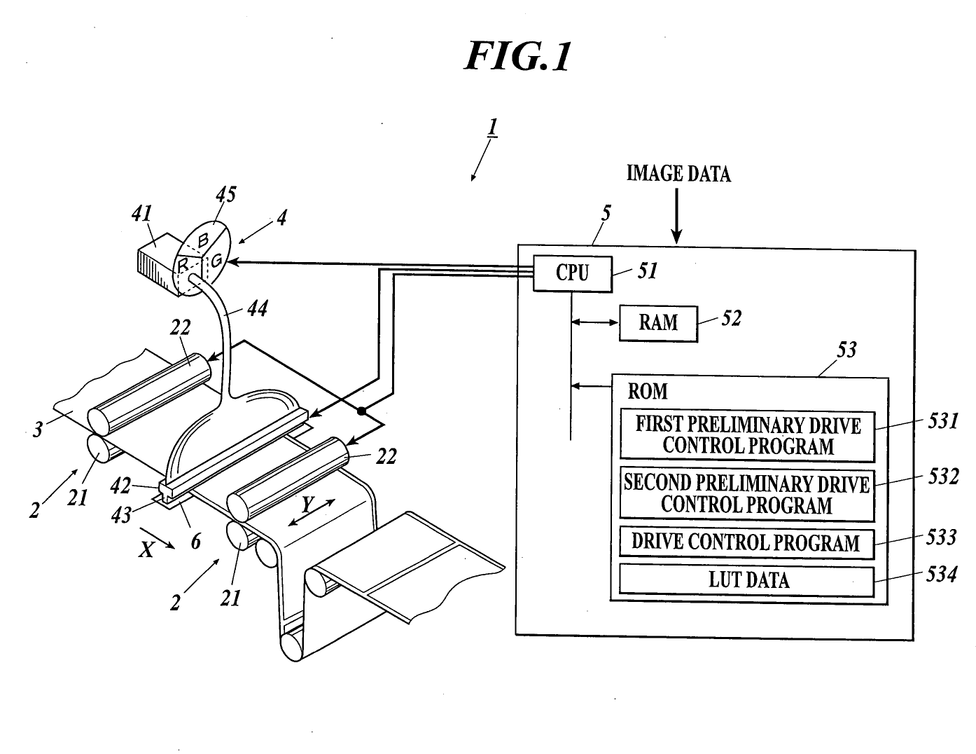

FIG. 1 is a schematic construction diagram of an image forming apparatus 1 to which the present invention is applied. The image forming apparatus 1 comprises a conveying mechanism 2 for conveying a silver halide photographic sensitive material (hereinafter, referred to as a “photographic paper”) 3 as a recording material in a conveying direction X (sub-scanning direction X), an exposure mechanism 4 as a recording head for forming an image on the photographic paper 3 linearly along a scanning direction Y (main scanning direction Y) perpendicular to the conveying direction X, a drive control unit 5 for performing drive control of the mechanism 2 and the mechanism 4 on the basis of image data (hereinafter, referred to as “image data”) of each exposure color of inputted light source colors R, G and B, and a supporting member 6 for supporting the sensitive material from below in a spot exposed linearly by the exposure mechanism 4.

The conveying mechanism 2 comprises drive rollers 21 and 21 that rotate around the shaft center perpendicular to the conveying direction X by a power source such as a motor, and press-contact rollers 22 and 22 that are brought into pressure contact with each of the drive rollers 21 and 21 in parallel therewith. One pair of the drive roller 21 and the press-contact roller 22 is installed upstream of the conveying direction X, and the other pair of the drive roller 21 and the press-contact roller 22 is installed downstream of the conveying direction X. The photographic paper 3 led out from a supply position (not shown) is nipped between the drive roller 21 and the press-contact roller 22 so as to be conveyed in the conveying direction X by the rotation of the drive rollers 21 and 21.

The photographic paper 3 is a silver halide photographic sensitive material. In the paper 3, a layer structure is formed by color forming layers that form respective colors. The layer structure has, from near the surface, a layer that is exposed to a red light (R) to form cyan, a layer that is exposed to a green light (G) to form magenta and a layer that is exposed to a blue light (B) to form yellow. The photographic paper 3 is rolled in the supply position (not shown).

The exposure mechanism 4 comprises a white light source 41 as a light source such as a halogen lamp that emits white light, an exposure head 42 arranged opposite the photographic paper 3 between two drive rollers 21 and 21, a Selfoc lens array 43 installed between the exposure head 42 and the photographic paper 3, an optical fiber array 44 that guides light from the white light source 41 to the exposure head 42 and a rotary color filter 45 that intervenes between one end of the optical fiber array 44 and the white light source 41. Further, from the viewpoint of speeding up of the control, an LED is preferably used for the light source.

The conveying mechanism 2 conveys the photographic paper 3. The exposure mechanism 4 records an image in the paper 3.

The exposure head 42 is a PLZT shutter array head where a plurality of PLZT (Plomb Lanthanum Zirconate Titanate) elements as recording elements are arrayed, as picture elements of light emitting points, along the scanning direction Y.

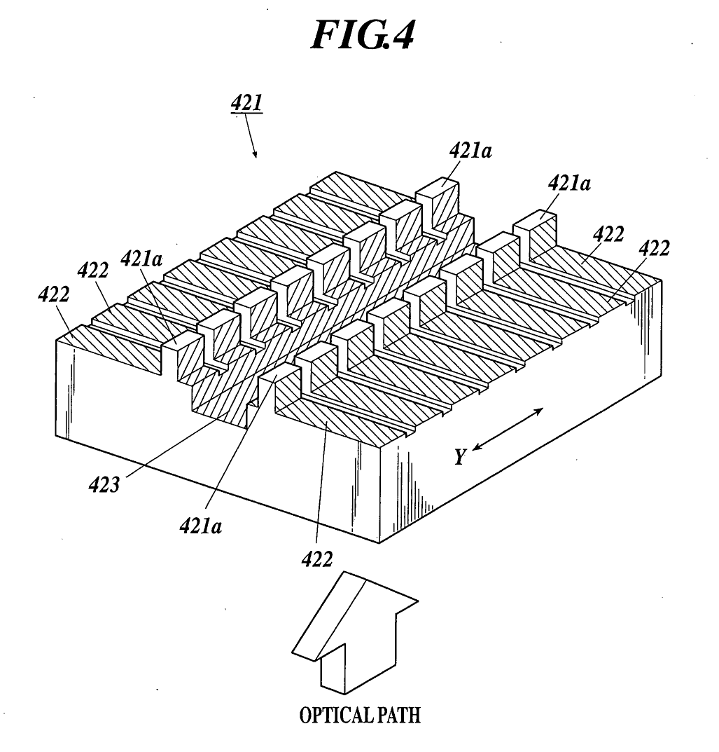

Concretely, the exposure head 42 has a structure that on a ceramic or glass base (not shown) having a slit opening, a plurality of light shutter chips 421 composed of the PLZT elements are arranged to form an array and drive circuits (not shown) are arranged on both sides of the light shutter chips 421. As shown in FIG. 4, a plurality of the PLZT elements 421a corresponding to one picture element are formed on each light shutter chip 421. The PLZT elements 421a form two rows. Each of the elements 421a is formed in a staggered state by one picture element. The elements 421a in two rows form a one-line image in the main scanning direction Y.

As shown in FIG. 4, the light shutter chip 421 is formed to have a three-dimensional shape and has an individual electrode 422 and a common electrode 423. When the electrodes 422 and 423 are provided in parallel with each other relative to an optical path, a large light transmission amount can be obtained even by a low drive voltage.

As is well known, the PLZT is a translucent ceramic with an electro-optic effect, which is high in a Kerr constant. In light linearly polarized by a polarizer (not shown), the polarized plane is rotated by turning on the voltage applied to the PLZT elements 421a. Then, the light is emitted from an analyzer (not shown). During the turning-off of the voltage, the polarized plane of transmitted light does not rotate and the transmitted light is cut by the polarizer (not shown).

That is, on/off of the drive voltage applied to each PLZT element 421a causes on/off of the transmitted light. Light emitted from the analyzer (not shown) forms an image on the photographic paper 3 via the Selfoc lens array 43. The PLZT elements 421a are on/off-controlled (main-scanned) by one line on the basis of the image data. By the main scanning and the movement of the paper 3 in the X direction (sub-scanning), a two-dimensional image is formed on the paper 3.

The Selfoc lens array 43 is constructed by a plurality of optically equivalent Selfoc lenses integrated in parallel with each other. The array 43 allows the light transmitted through the exposure head 42 to form an image on the paper 3.

In other words, an object surface of the Selfoc lens array 43 is adjusted to the exposure head 42 via the analyzer (not shown), and the imaging surface of the Selfoc lens array 43 is adjusted to the photographic paper 3. In addition, the exposure spot is a spot exposed linearly along the scanning direction Y on the imaging surface of the Selfoc lens array 43. The length of the exposure spot along the scanning direction Y is substantially the same as that where the emitting points of the exposure head 42 are arrayed.

At one end of the optical fiber array 44, one end of plural optical fibers is bound up. The end of the array 44 is directed to the color filter 45 and the white light source 41. At the other end of the array 44, the ends of the optical fibers are each connected up to the PLZT elements as the light shutter elements.

The color filter 45 has a disk-like shape. The disk-shaped filter is divided into three equal parts by 120°. In the three equal parts, Red (R), green (G) and blue (B) colors are arranged, respectively. A central axis of the disk is connected to a driving source (not shown). When the color filter 45 rotates, each filter of each of colors R, G and B is selectively arranged on an optical path from the white light source 41 up to one end of the array 44.

The drive control unit 5 performs drive control of the drive roller 21, the exposure head 42 and the color filter 45, for example, on the basis of the image data. The unit 5 comprises a CPU (Central Processing Unit) 51, a RAM (Random Access Memory) 52 and a ROM (Read Only Memory) 53.

The CPU 51 performs, in response to a predetermined timing, various calculations, instructions to each function unit or transfers of data on the basis of various programs stored within the ROM 53.

The RAM 52 is used for temporarily storing data processed by the CPU 51 as well as for outputting the stored data to the CPU 51 under the drive control of the CPU 51.

The ROM 53 mainly stores the programs or data for various operations executed in the conveying mechanism 2 and the exposure mechanism 4. Specifically, the ROM 53 stores, for example, a first preliminary drive control program 531, a second preliminary drive control program 532, a drive control program 533 and LUT data 534, as shown in FIG. 1.

The program 531 is a program for driving the PLZT elements constituting the exposure head 42 to perform preliminary light emission before starting recording in the paper 3 after application of power to the apparatus 1. The CPU 51 functions as first preliminary drive control member when executing the program 531.

The preliminary light emission is performed by driving the PLZT elements constituting the exposure head 42. Since the preliminary light emission is performed immediately before starting exposure on the sensitive materials, the PLZT elements have only to be driven during the preliminary light emission. The elements may or may not emit light during the light emission.

The second preliminary drive control program 532 is a program for dividing the image data inputted to the drive control unit 5 into the image data of a predetermined low record amount area and the image data other than that of the low record amount area; and performing fine light emission after starting recording in the photographic paper 3 by driving, on the basis of the divided image data of the low record amount area, the PLZT elements constituting the exposure head 42 in the range where the light emission amount does not contribute to the image formation. Herein, in the case of using the photographic paper 3 as recording materials as in the present embodiment, the “low record amount area” means a “low density area”. The image data of the low record amount area means the image data of the low density area (hereinafter, referred to as a “low density image data”).

The CPU 51 functions as the second preliminary drive control member when executing the second preliminary drive control program 532.

In other words, the CPU 51 is designed to control the PLZT elements constituting the exposure head 42 so as to perform recording with a predetermined record amount as the second preliminary drive control member.

Herein, the “record amount” is an amount resulting from multiplying the “record strength” by the “drive time” and the “coefficient”. The “record strength” means an energy strength given to the recording materials by the recording head. The “drive time” means a time for the recording elements constituting the recording head to drive. The “coefficient” means, for example, a coefficient related to material characteristic of recording materials. Particularly, when the sensitive material is used as the recording material and difference in sensitivity due to sensitive material types and lot variations is extremely large, also the correction amount for correcting the sensitivity is included. The recording may be performed by setting a coefficient for each of the sensitive material types and by appropriately changing the coefficient.

Between the record amount (E), and the record strength (A), the drive time (t) and the coefficient (k), a relation of E=A×t×k is established. Therefore, adjustment of the record amount can be performed by any one of adjustment of the record strength or adjustment of the drive time.

Further, when the sensitive material is used as the recording material, the “record amount” can be changed for a “light emission amount” or an “exposure amount”, the “record strength” can be changed for a “light emission strength” or an “exposure strength” and the “drive time” can be changed for a “light emission time” or an “exposure time”.

Accordingly, when using the photographic paper 3 (a silver halide photographic sensitive material) as the recording material and further using the exposure head 42 as the recording head as in the present embodiment, the following relational expression is used. That is, the relational expression of A (record amount)=E (record strength)×t (drive time)×k (coefficient) is changed to A (light emission amount)=E (light emission strength)×t (light emission time)×k (coefficient) or A (exposure amount)=E (exposure strength)×t (exposure time)×k (coefficient).

Further, fine light emission means drive of the PLZT element that records the image of a predetermined low density area. The CPU 51 as the second preliminary drive control member executes a program for performing fine light emission by always driving and controlling the PLZT element corresponding to the low density image data during the image formation on the basis of the values converted by the LUT data 534 (described in detail later).

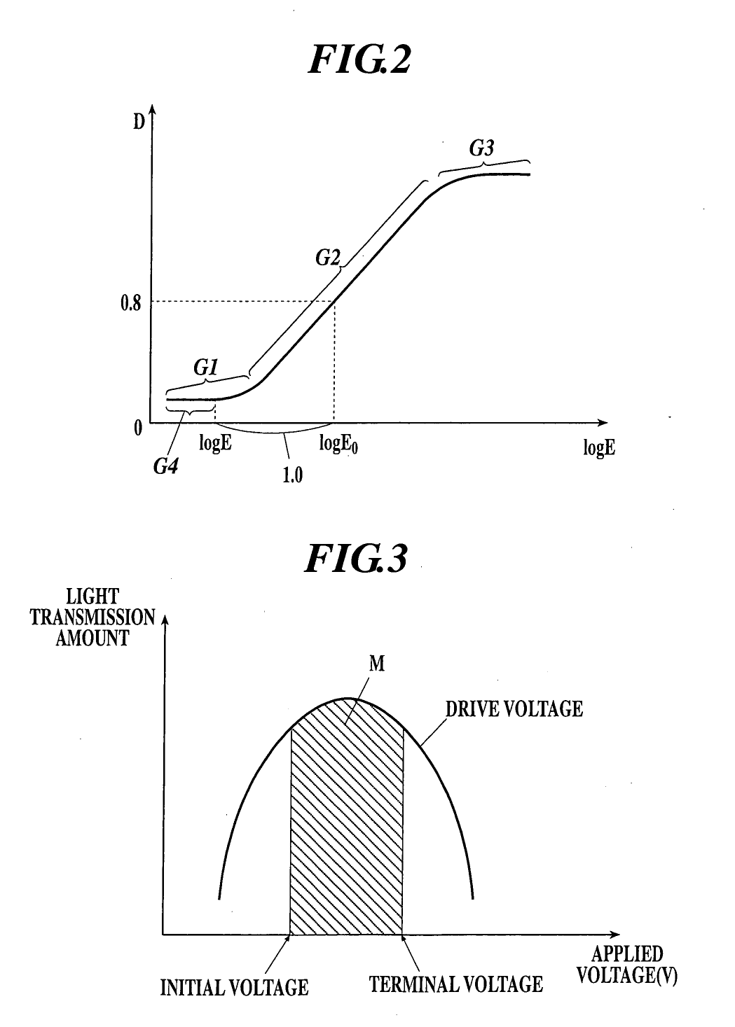

Herein, the predetermined low record amount area as the “predetermined area” to be recorded in a predetermined low record amount is determined on the basis of the characteristic curve of the recording material shown in FIG. 2. The characteristic curve of the recording material is a characteristic curve where the horizontal axis shows a logarithm of the record amount and the vertical axis shows an image density relative to the record amount. Specifically, as shown in FIG. 2, the characteristic curve of the recording material comprises a first curve section (G1), a straight section (G2) and a second curve section (G3). The “predetermined low record amount area” indicates the first curve section (G1). In the G1 section, a change of the density relative to a change of the logarithm of the record amount (slope of the graph) is small as compared with that in the straight section (G2).

It is more preferable that the “predetermined low record amount area” is an area where the change of the density (slope of the graph) is almost equivalent to zero as in the G4 section.

Further, “to always perform” herein means that the recording element must always be driven when driving the recording head. The second preliminary drive controlling member does not perform the second preliminary drive between the lines where the recording head dose not drive.

Herein, the light emission amount of the fine light emission, which is a record amount in the predetermined low density area, is sufficiently smaller than that of the preliminary light emission. More specifically, the light emission time of the fine light emission is shorter than that of the preliminary light emission. The light emission time of the fine light emission is from 1 to 20% of that of the preliminary light emission. The reason why the light emission time of the fine light emission is set to 20% or less of that of the preliminary light emission is that when the light emission time of the fine light emission is more than 20% of that of the preliminary light emission, density irregularity or displacement of the color balance occurs due to increasing light emission in the low density area. The reason why the light emission time of the fine light emission is set to 1% or more of that of the preliminary light emission is that when the light emission time of the fine light emission is less than 1% of that of the preliminary light emission, light emission becomes substantially zero, the object of the invention is lost, and density irregularity or displacement of the color balance occurs.

The CPU 51 as the second preliminary drive control member recognizes, as the low density image data, the image data corresponding to the image formed in the exposure amount that an exposure amount difference from the exposure amount capable of obtaining the reference density is −1.0 or less (preferred example) in the characteristic curve of the photographic paper 3.

Herein, the “reference density” is a density to be used as a reference at the time of adjustment of the record amount of each PLZT element as each recording element, which is performed during the setup of the image forming apparatus. In other words, the “reference density” means a density to be outputted on the basis of the input signal value as a reference at the time of adjustment of the record amount of the PLZT element.

More specifically, in a graph of FIG. 2 showing the material characteristic of the photographic paper 3, when the exposure amount capable of recording the reference density (e.g., 0.8) is expressed as E₀, the image data of the low density area recorded in the exposure amount E satisfying log E−log E₀≦−1.0 is recognized as the low density image data. Concretely, the image data of an area to be recorded in the exposure amount of the G4 portion in FIG. 2 is recognized as the low density image data.

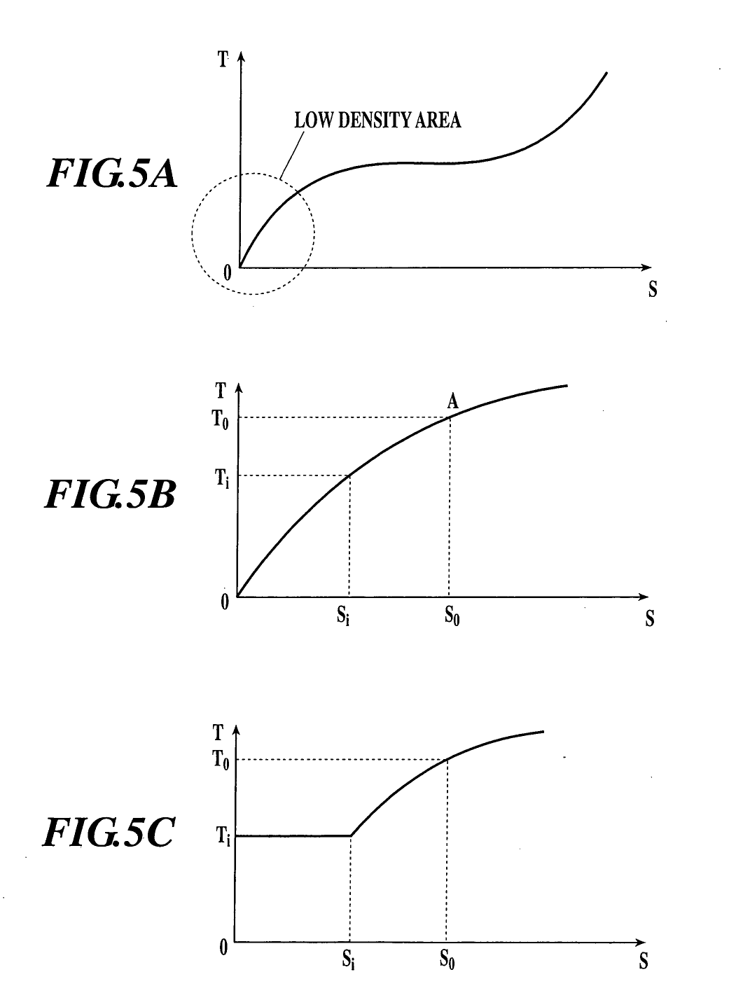

A graph shown in FIG. 5A is one example of the LUT data 534. The horizontal axis shows an input signal value (S) obtained on the basis of the image data related to the image formation inputted to the drive control unit 5. The vertical axis shows an output signal value (T) inputted to the exposure head 42.

FIG. 5B is an enlarged view of the low density area in FIG. 5A. In a point A, the input signal value (S₀) capable of obtaining the reference density (0.8) and the output signal value (T₀) are correlated.

Herein, The input signal value (S₀) in which the standard density (0.8) can be obtained is in the range of 60≦S₀≦140, preferably 80≦S₀≦130.

The reason why the lower limit of S₀ is 60 is that S₀ of lower than 60 causes density irregularity or displacement of the color balance. The reason why the upper limit of S₀ is 140 is that S₀ of higher than 140 also causes density irregularity and displacement of color balance.

The input signal value (S₀) in which the standard density can obtained is, for example, a 8 bit signal value whose minimum value is 0 and maximum value is 255.

Next, the relation between the input signal value (S) and the exposure amount (E) is explained.

The following relational expression (1) is established between the input signal value (S) and the exposure amount (E):
log E=−log(S/4095) (1)
By substituting the relational expression (1) in the above-described expression (2) expressing a range of the low density area:
log E-log E₀≦−1.0 (2)
the low density area is defined by the input signal value (S).

That is, from an expression (3):
−log(S/4095)−(−log(S_{0/}4095))≦−1.0 (3)

the low density area is an area comprising the input signal values (S) satisfying the following expression (4):
log(S/S₀)≦−1.0 (4)

Therefore, the low density area is also an area to be recorded by the input signal value (S) set on the basis of the input signal value (S₀) capable of obtaining the reference density (0.8). The signal value (S) satisfies the expression: log(S/S₀)≦−1.0 in the characteristic curve of the photographic paper 3.

The drive control program 533 is a program for alternately inverting and applying, between the individual electrode 422 and the common electrode 423, an electrolysis in a predetermined cycle on the basis of the image data after starting the recording in the photographic paper 3 to perform a normal light emission for recording an image corresponding to the image data. The CPU 51 functions as the drive control member when executing the drive control program 533.

In the LUT data 534, the input signal value obtained on the basis of the image data related to the image formation inputted to the drive control unit 5 and the output signal value inputted to the exposure mechanism 4 are correlated.

Specifically, as shown in FIG. 5C, the above-described input signal value (S) satisfying the expression: log(S/S₀)≦−1.0 and the output signal value (T) are correlated. More specifically, when the image data as the low density image data are inputted to the exposure head 42, the output signal values inputted to the exposure head 42 are equally converted to the output signal values (Tᵢ) satisfying the expression: log Eᵢ-log E₀=−1.0 and then outputted.

FIG. 5C is a diagram obtained by converting the output signal value relative to the input signal value (S) in the low density area to a constant output signal value (Tᵢ).

The “predetermined low record amount” means record amount recorded according to the output signal value (Tᵢ) corresponding to a predetermined input signal value when the predetermined input signal value (0 to Sᵢ) which shows low record amount area is input in FIG. 5C.

The supporting member 6 is arranged on the side opposite the exposure head 42 through the Selfoc lens array 43. The member 6 is a plate-like transparent glass member perpendicular to an optical axis of the Selfoc lens array 43 between two drive rollers 21 and 21. The member 6 is installed in long size along the scanning direction Y. The photographic paper 3 is conveyed while sliding onto the member 6 between the member 6 and the Selfoc lens array 43.

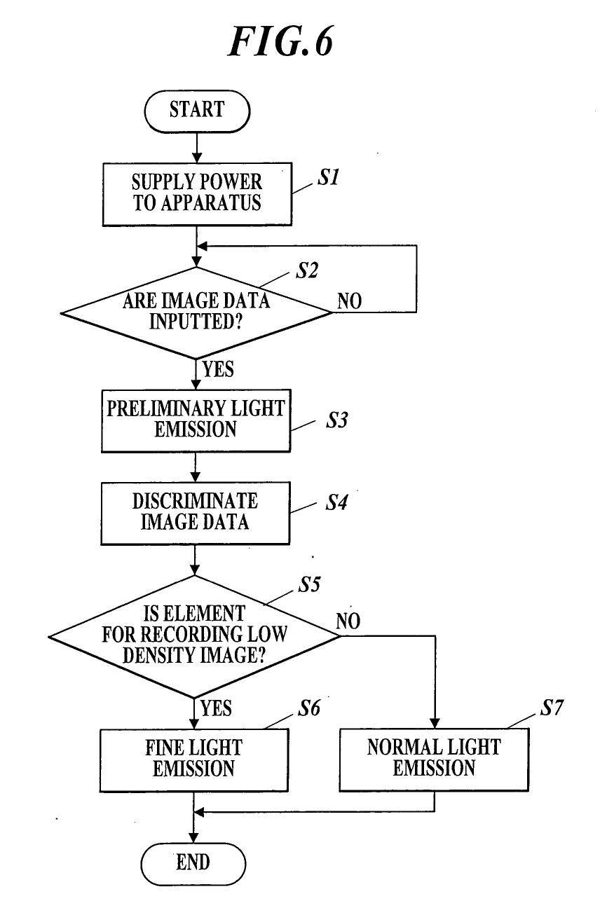

One example of the drive of the PLZT elements 421a constituting the exposure head 42 of the image forming apparatus 1 described above is described by referring to the flow chart shown in FIG. 6.

First, power is applied to the image forming apparatus 1 (step S1). The CPU 51 decides whether the image data are inputted to the drive control unit 5 or not (step S2). When the CPU 51 decides that the image data are not inputted (No in step S2), the image forming apparatus 1 goes to a wait state. When deciding that the image data are inputted (Yes in step S2), the CPU 51 executes the first preliminary drive control program 531 to perform the preliminary light emission by driving the PLZT elements (step S3; the first preliminary drive control step). Next, the CPU 51 executes the second preliminary drive control program 532 to discriminate the low density image data from image data other than the low density image data (step S4; the second preliminary drive control step).

In step S5, the CPU 51 executes the second preliminary drive control program 532 to decide whether the PLZT element is an element for recording the low density image (step S5; the second preliminary drive control step). When deciding that the element is an element for recording the low density image (Yes in step S5), the CPU executes the second preliminary drive control program 532 on the basis of the value converted by the LUT data 534 to perform the fine light emission (step S6; the second preliminary drive step).

On the other hand, when deciding that the element is not an element for recording the low density image (No in step S5), the CPU 51 executes the drive control program 533 for performing the normal light emission (step S7) to record the image in the photographic paper 3 and then completes the drive of the PLZT elements.

According to the image forming apparatus 1 of the first embodiment described above, since preliminary light emission is performed before starting recording, variation in drive history of each PLZT element, namely, variation in the record amount of each PLZT element is suppressed. As a result, change of the image density is reduced so as to prevent the degradation of the image quality.

Further, since the fine light emission is performed in the record amount in the range of not contributing to the image formation even after starting recording, an effect of the preliminary light emission can be maintained. As a result, regardless of the image density of one sheet of the printed image (print), the change of the image density can be suppressed so as to prevent the degradation of the image quality.

Further, since the record amount of the fine light emission is set to from 1 to 20% of that of the preliminary light emission, the effect of the fine light emission is maintained as well as excessive recording is prevented. As a result, the change of the image density can be more effectively suppressed so as to prevent the degradation of the image quality.

Further, since the fine light emission can be performed by adjusting the drive time of the PLZT element, the change of the image density can be easily suppressed.

Further, particularly also in the image where predetermined low density areas liable to lose an effect of the preliminary light emission are continuously present, since the drive of the PLZT element is always performed, reduction in the light emission amount of the PLZT element for recording the image of the low density area can be prevented. As a result, the change of the image density can be more surely suppressed regardless of the image density.

Further, since the density range in which the fine light emission is performed is limited to a sufficiently low density range as compared with the density range capable of obtaining the reference density, the fine light emission can be performed while suppressing an adverse effect on the paper 3. As a result, the effect of the preliminary light emission is maintained without any effect on an actual image so as to prevent the degradation of the image quality.

Further, since the PLZT elements are driven by using the LUT data where the input signal value and the output signal value are correlated, an output value appropriate to an input value is obtained without performing complicated controls. As a result, the drive of the recording elements can be readily and surely controlled so as to suppress the change of the image density.

Further, the input signal value S in a sufficiently low range as compared with an arbitrary input signal value S₀ capable of obtaining the reference density can be set. Therefore, in an arbitrary photographic paper 3, the effect of the preliminary light emission can be maintained without any restriction on the input signal value S₀ (material characteristic) of the photographic paper 3, in other words, without any effect on an actual image so as to prevent the degradation of the image quality.

Further, since the input signal value S₀ is set to the range of 60≦S₀≦140, the reference density does not go to an extremely high density or low density so that a preferable image quality can be obtained.

Further, since this configuration is applied to the PLZT shutter array head, leakage light as a problem of the PLZT shutter array head, more specifically, decrease of the exposure amount due to leakage light dependent on a history of the recording performed by the PLZT shutter can be reduced.

Moreover, since alternating drive is performed, a residual charge amount charged to the electrodes can be reduced so that density change or density irregularity change can be reduced.

### Second Embodiment

Next, the second embodiment of the present invention is described in detail by referring to the drawings. In an image forming apparatus 100 according to the second embodiment, an exposure mechanism 104, a drive control unit 105 and an image reading unit 107 are different from those in the first embodiment. Accordingly, when describing the second embodiment, the same elements as those in the first embodiment are indicated by the same reference numerals as in the first embodiment and their descriptions are omitted.

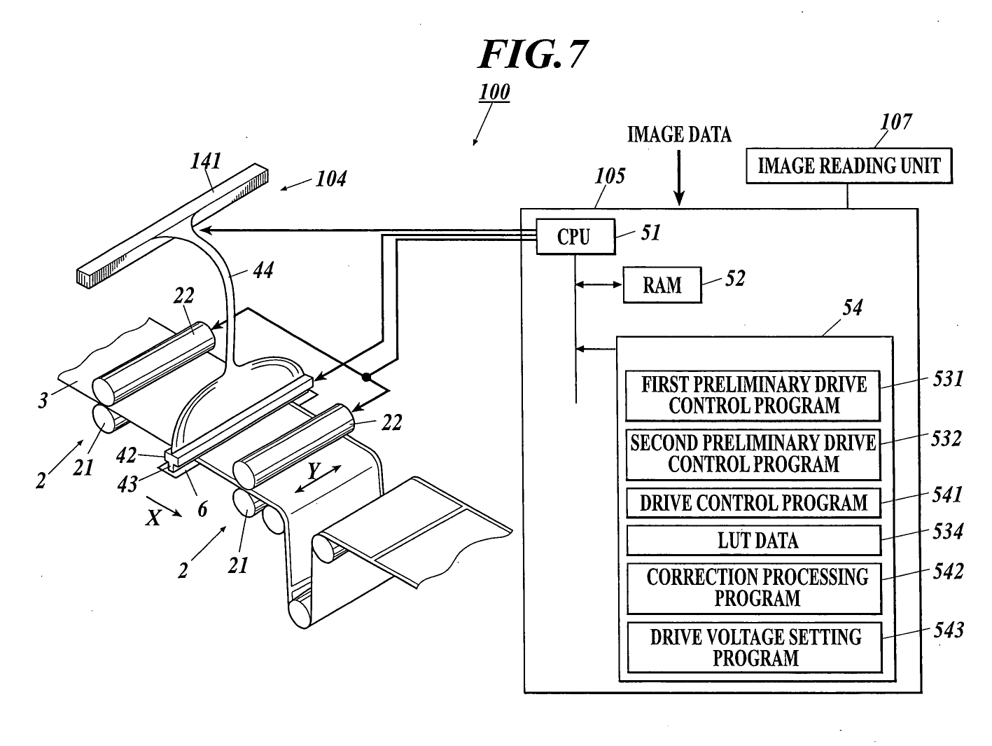

As shown in FIG. 7, the image forming apparatus 100 comprises a conveying mechanism 2 for conveying a photographic paper 3 in a conveying direction X, an exposure mechanism 104 for forming an image on the photographic paper 3 linearly along a scanning direction Y perpendicular to the conveying direction X, a drive control unit 105 for performing drive control of the mechanism 2 and the mechanism 104, a supporting member 6 for supporting the sensitive material from below in a spot exposed in an array-like manner by the exposure mechanism 104, and an image reading unit 107.

The exposure mechanism 104 comprises an LED light source 141, which includes three primary colors (exposure colors) of R, G and B, in place of the white light source 41 and the color filter 45 in the first embodiment, an exposure head 42 arranged opposite the photographic paper 3 between two drive rollers 21 and 21, a Selfoc lens array 43 installed between the exposure head 42 and the photographic paper 3, and the optical fiber array 44 that guides light from the LED light source 141 to the exposure head 42.

Herein, the “three primary colors” are preferably the colors that a peak wavelength of each of the three primary colors is in the range of 400 to 500 nm in B (blue), 500 to 600 nm in G (green) and 600 to 700 nm in R (red).

The LED light source 141 is constituted by arraying a plurality of light source elements of R, G and B. In the source 141, sequential switching among R, G and B light are conducted to allow each color to enter each PLZT element. In this case, adjustment of the light emission amount of the PLZT element may be performed by the light emission time. The adjustment thereof may also be performed by adjusting the light emission intensity through controlling the LED current of each LED light source element.

The drive control unit 105 comprises a CPU 51, a RAM 52 and a ROM 54. The ROM 54 includes a first preliminary drive control program 531, a second preliminary drive control program 532, a drive control program 541, a LUT data 534, a correction processing program 542 and a drive voltage setting program 543.

The drive control program 541 is a program executed on the basis of the light emission amount correction coefficient, which is obtained by the correction processing program 542 (described in detail later), adjusted on the basis of the correction information of each PLZT element constituting the exposure head 42. In the program, normal light emission is performed by driving each recording element to record images in the photographic paper 3. The CPU 51 functions as the drive control member when executing the drive control program 541.

The correction processing program 542 is a program for performing adjustment of the light emission amount correction coefficient using the correction amount of the recording characteristic, which is obtained on the basis of the correction information of the PLZT elements constituting the exposure head 42. In the program, the adjustment is performed after the preliminary light emission is performed. More specifically, the program 542 is a program for executing adjustment of the light emission amount correction coefficient on the basis of the correction image 108 recorded in the photographic paper 3 by the exposure head 42. The CPU 51 functions as the correction processing member when executing the correction processing program 542.

Herein, the correction information means read information capable of obtaining characteristics of each recording element. For example, the information includes not only read information obtained by reading, using CCD (Charge Coupled Device), the density of images recorded in recording materials but also read information obtained by directly measuring, using sensors, the record amount of plural recording elements constituting the recording head. In the present embodiment, the correction information means, for example, density data (described later) obtained by reading, using the image reading unit 107, an image recorded by the exposure head 42. Further, the correction amount of the recording characteristic is an amount indicating a level (a level requiring correction) of deviation from an appropriate range of the record amount of each recording element. For example, as the level of deviation from an appropriate range is larger, the correction amount more increases. On the other hand, as the level of deviation from an appropriate range is smaller, the correction amount more decreases. In the present embodiment, the correction amount means the level of deviation from an appropriate range of the light emission amount of each PLZT element. In addition, the correction amount of the recording characteristic is a coefficient for correcting the record amount of each recording element to an appropriate range. For example, when the recording element is insufficient in the record amount as compared with an average record amount of the recording head, a coefficient capable of increasing the record amount is given to the recording element. On the other hand, when the recording element is excessive in the record amount as compared with an average record amount of the recording head, a coefficient capable of decreasing the record amount is given to the recording element. In the present embodiment, the correction amount of the recording characteristic means a ratio of adjusting the light emission amount correction coefficient of each PLZT element so that each PLZT element of the array-like exposure head 42 may perform recording in the paper 3 with a uniform light emission amount. The CPU 51 as the correction processing member adjusts the light emission amount correction coefficient by using a correction amount corresponding to each PLZT element.

The drive voltage setting program 543 is a program for setting a drive voltage corresponding to each of the light source colors R, G and B. The CPU 51 functions as the drive voltage setting member when executing the drive voltage setting program 543. Further, a fixed drive voltage corresponding to each of the light source colors R, G and B may be set.

Herein, it is preferred that the drive voltage of each PLZT element of the PLZT shutter array head is set to a voltage where the light transmission of the PLZT element is maximized.

Herein, “the light transmission amount is maximized” means a case where the light transmission amount of each recording element is maximized, and further includes a case where an average light transmission amount of the recording elements in a particular range or in the whole range is maximized.

In addition, when the drive voltage accompanies variation per hour in response to the record amount, the “light transmission amount is maximized” in the present invention also includes a drive voltage such that an area M surrounded by an initial voltage and a terminal voltage is maximized as shown in FIG. 3. Herein, FIG. 3 is a diagram showing the drive voltage. In FIG. 3, the vertical axis shows a light transmission amount and the horizontal axis shows an applied voltage.

Further, it is preferred that when the PLZT shutter array head is constituted by a plurality of chips, the drive voltage can be set in each chip such that the average light transmission amount in each chip is maximized.

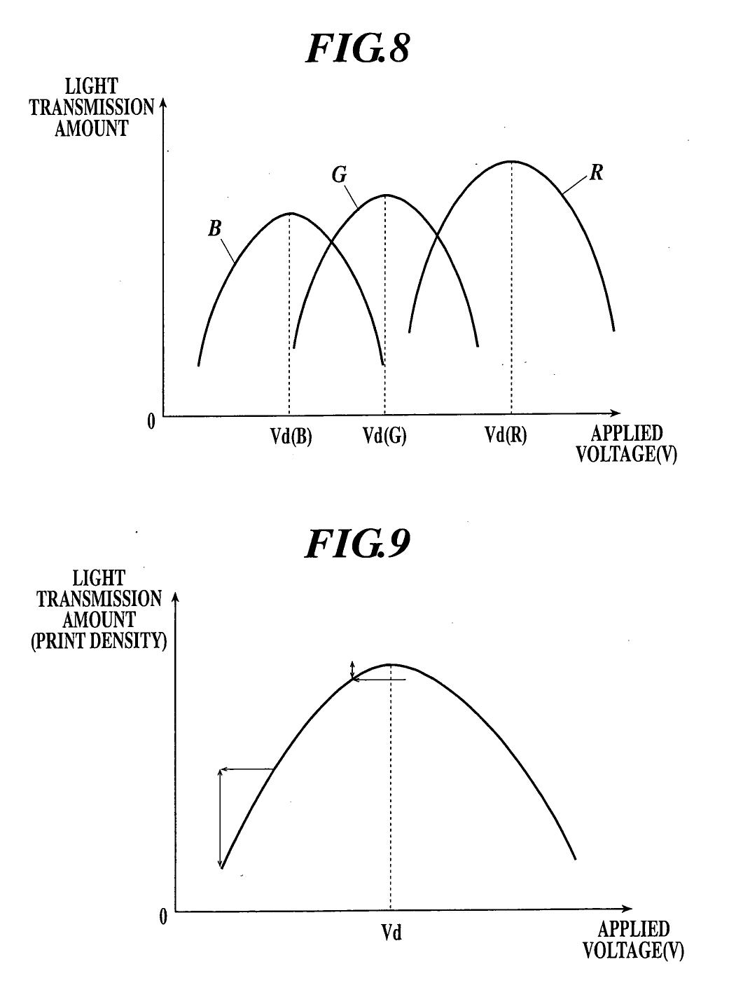

Concretely, during exposure of respective light source colors R, G and B, when voltages (Vd(R), Vd(G) and Vd(B)) where the light transmission amount of each of the colors R, G and B is maximized are set as the drive voltages in the diagram of FIG. 8 showing a transmittance distribution of the colors R, G and B through the PLZT light shutter, a change of the light transmission amount relative to a change of the drive voltage decreases and an allowance increases as shown in FIG. 9. As a result, the density change or density irregularity change can be suppressed so that the effect of the present invention can be more exerted.

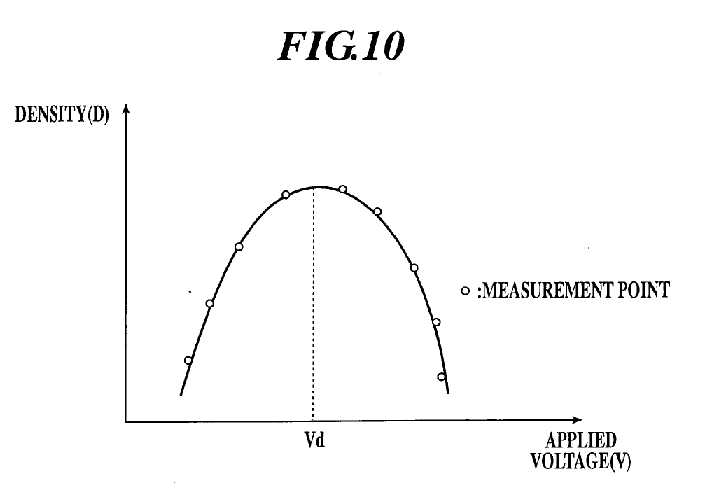

Herein, an optimal drive voltage, namely, the voltage (Vd) where the light transmission amount of the PLZT element is maximized can be obtained as follows. That is, the voltage is varied to perform recording in the sensitive materials, voltages and densities are correlated to perform complement as shown in FIG. 10, and the voltage where the density is maximized is determined.

The image reading unit 107 comprises a light source (not shown), a CCD (Charge Coupled Device; not shown) and an A/D converter (not shown). The image reading unit 107 irradiates light from a light source onto a manuscript placed on a manuscript base (not shown) and then converts the reflected light to electrical signals (analog signals) by the CCD to obtain read information such as density data. The obtained read information is converted to digital data by the A/D converter. The digital data are transmitted to the drive control unit 105 as density information indicating the density for each color component of the three colors R, G and B (hereinafter, referred to as “density data”).

Next, the correction image 108 created in the present embodiment is described.

FIG. 11 shows one example of the construction of the correction image 108. As shown in FIG. 11, an image, which is a so-called gray color image, formed by performing recording using each exposure color (reference color) of the colors R, G and B in the same spot to allow a cyan color component (Red exposure), a magenta color component (Green exposure) and a yellow color component (Blue exposure) as dyes of each reference color to be color-developed is preferably used in the acquisition area of the density information (hereinafter, referred to as the “density information acquisition area”) 118.

The correction image 108 may be an image recorded at intervals in the array direction of the PLZT elements, for example, an image recorded at intervals of at least one element or more in the array direction of the PLZT elements; however, it is preferred that the image 108 is a solid image recorded without intervals. Further, it is preferred that the image 108 is an image recorded with the same density as much as possible in the array direction of the PLZT elements. Accordingly, it is desired that the image 108 is a solid image with an almost uniform gray color. Further, it is preferred that the image 108 is not a general image but an image mainly used for correcting density irregularities of the exposure head.

It is preferred that in the correction image 108, the density range of the density information acquisition area 118 is set to a straight portion of the characteristic curve of the photographic paper 3. The straight portion is a portion such that in the characteristic curve of the photographic paper shown in FIG. 2, the density change relative to the logarithm change of the exposure amount (slope of the graph) is constant as shown in the G2 portion.

More specifically, in the correction image 108, the density range of the area 118 is preferably from 0.3 to 1.5, more preferably from 0.4 to 1.0, and most preferably from 0.5 to 0.7 in terms of a Red density. Further, the density range thereof is preferably from 0.2 to 1.5, more preferably from 0.3 to 0.8, and most preferably from 0.4 to 0.6 in terms of a Green density. Further, the density range thereof is preferably from 0.15 to 1.5, more preferably from 0.3 to 1.0, and most preferably from 0.4 to 0.6 in terms of a Blue density.

Further, it is preferred that the density information acquisition area 118 is recorded with a plurality of different image data, namely, with a plurality of different densities in a plurality of different areas of the correction image as shown in FIG. 11.

Herein, the “different areas” mean that the position on the chart is different. It is preferred that the different areas provide different read information. In addition, it is preferred that the different areas are recorded with the different densities.

Further, it is preferable that position of the area on the chart is different with respect to conveying direction.

It is preferred that adjustment of the light emission amount correction coefficient is performed by comparing the correction information of the different density information acquisition areas 118 or by the statistics value of the correction information of the different density information acquisition areas 118.

The “statistics value” preferably used herein is one quantitatively indicating the whole distribution characteristics by one numerical value. An average, a median, a quartile deviation, a mode and a root mean square are preferably used.

It is preferred that the correction image 108 has a marker section used for specifying the position of the PLZT element. An interval between markers in the array direction of the recording elements is preferably narrow. For example, the interval between markers is preferably set to 10 picture elements or less, more preferably 5 picture elements or less, and most preferably one picture element. One picture element interval means that ON and OFF are repeated in the array direction of the PLZT elements.

Further, it is preferred that the correction image 108 has a positioning marker (not shown) for fixing a number for an array order of the corresponding PLZT elements. The positioning marker may be any as long as it has a state definitely different from that of a regular marker. For example, the marker may be one recorded with a density largely different from that of a regular marker.

When the positioning marker is recorded with a density lower than that of a regular marker, the position of the positioning marker can be specified because low density portions are continued in the positioning marker portion. Since the absolute position of the marker can be specified, the recording element number can be fixed for picture elements in the vicinity of the marker. Accordingly, on the basis of the correction amount determined from the obtained density, an accurate feedback to each recording element can be performed.

In the leading portion of the density information acquisition area 118 of the correction image 108, there is recorded an image, which is a so-called gray color image (gray image), formed by color-developing a cyan color component (Red exposure), a magenta color component (Green exposure) and a yellow color component (Blue exposure).

Immediately before the gray image 119 is recorded, the preliminary light emission is performed by driving all the PLZT elements constituting the exposure head 42.

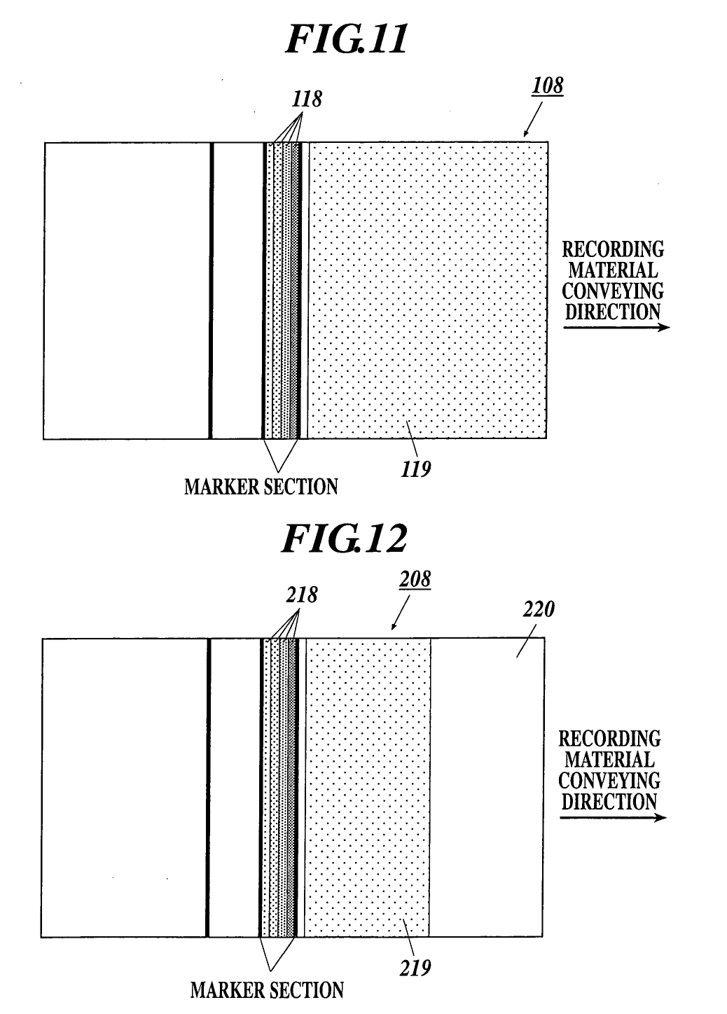

Another example of the correction image includes a correction image 208 shown in FIG. 12. The image 208 may have a low density area 220 in addition to a density information acquisition area 218 and a gray image 219. It is preferred that before starting the recording of the low density area 220, the preliminary light emission is performed by driving all the PLZT elements and the drive (fine light emission) of the PLZT elements by the second preliminary drive is performed in the low density area 220 even after starting the recording.

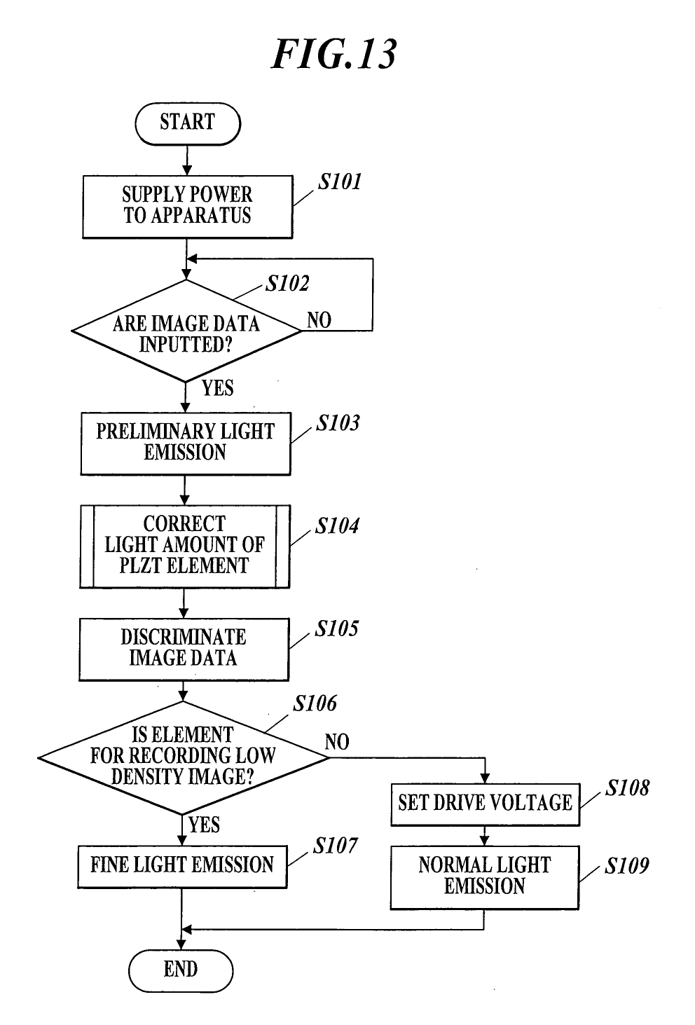

One example of the drive of the PLZT elements constituting the exposure head 42 of the image forming apparatus 100 described above is described by referring to a flow chart shown in FIG. 13.

As shown in FIG. 13, first, power is applied to the image forming apparatus 100 (step S101). The CPU 51 decides the presence or absence of the image data (step S102). When the CPU 51 decides that the image data are not inputted (No in step S102), the apparatus 100 goes to a wait state. When deciding that the image data are inputted (Yes in step S102), the CPU 51 executes the first preliminary drive control program 531 to perform the preliminary light emission by driving the PLZT elements (step S103; the first preliminary drive control step). Next, the CPU 51 executes the correction processing program 542 (step S104; correction processing step) to adjust the light emission amount correction coefficient. Then, the CPU 51 proceeds to step S105 and executes the second preliminary drive control program 532 to discriminate the low density image data from image data other than the low density image data (step S105; the second preliminary drive-control step).

Next, the CPU 51 executes the second preliminary drive control program 532 to decide whether the PLZT element is an element for recording the low density image or not (step S106; the second preliminary drive control step). When deciding that the element is an element for recording the low density image (Yes in step S106), the CPU 51 executes the second preliminary drive control program 532 on the basis of the value converted by the LUT data 534 to perform the fine light emission (step S107; the second preliminary drive member).

When deciding that the element is not an element for recording the low density image (No in step S106), the CPU 51 sets the drive voltages in response to light source colors to be exposed (step S108; drive voltage setting step). Next, the CPU 51 executes the drive control program 541 on the basis of the light emission amount correction coefficient obtained in the correction processing step to perform the normal light emission (step S109; drive control step) for recording the image in the photographic paper 3 and then completes the drive of the PLZT elements.

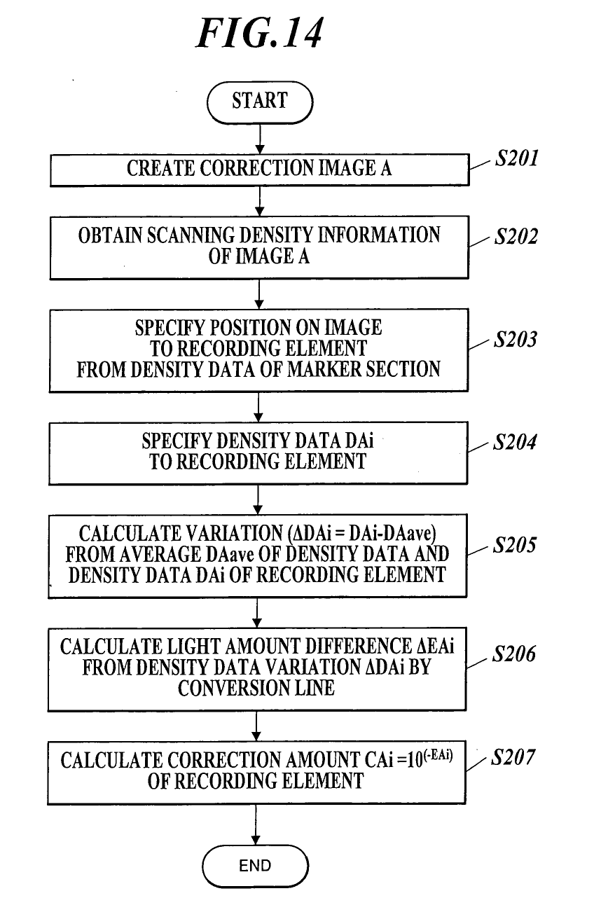

Next, the light emission amount correction processing of the PLZT element performed by the image forming apparatus 100 is described in detail by referring to a flow chart shown in FIG. 14.

First, the CPU 51 creates a photographic paper where a correction image A is recorded (step S201). Next, the CPU 51 conveys the correction image A to the image reading unit 107 to set the image A. Further, the CPU 51 performs scanning of the correction image A to obtain density information (step S202). Concretely, the CPU 51 obtains density data corresponding to each of the reference colors R, G and B in each position of the correction image A. In order to obtain the density of the correction image A corresponding to each of the PLZT elements with high accuracy, it is preferred that the image reading unit 107 performs reading of the correction image A with a resolution higher than that where the exposure head 42 performs recording.

Further, the CPU 51 specifies the position of the positioning marker (not shown) from the continuing low density portion of the density data of the marker section, and fixes the PLZT element numbers in the vicinity of the marker (step S203). Thus, the CPU 51 specifies the density data DAi corresponding to each PLZT element i of each print head (step S204).

Next, the CPU 51 calculates the variation ΔDAi=DAi-DAave under the assumption that the average in the array direction of the PLZT elements of the density data DAi obtained from the correction image A is DAave (step S205).

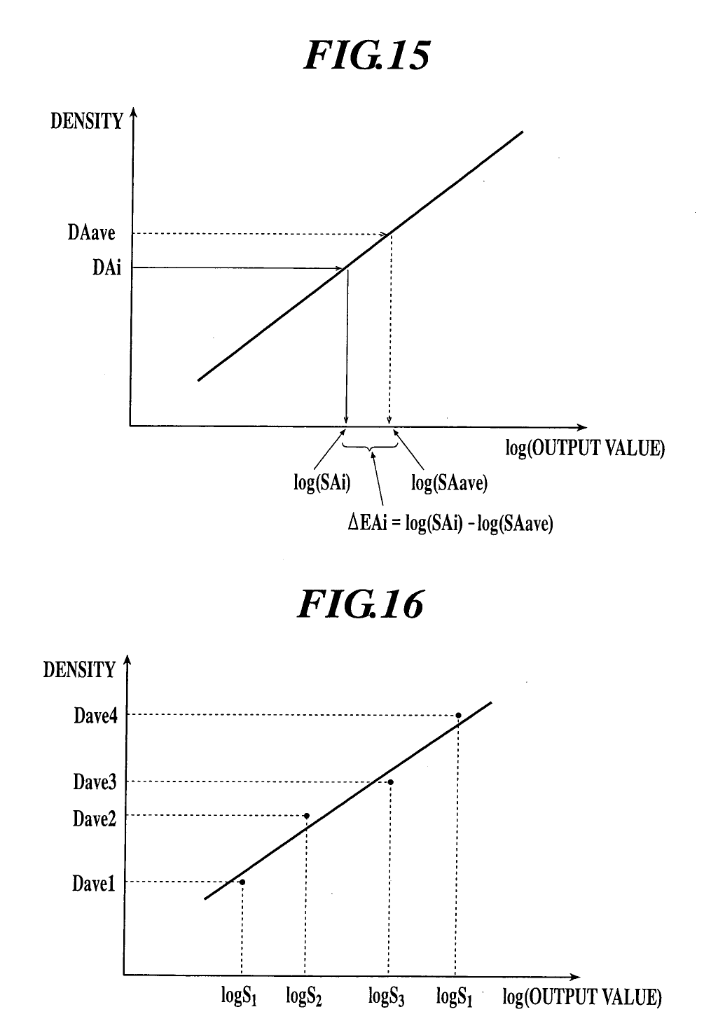

Next, the CPU 51 finds the light amount difference ΔEAi of respective PLZT elements by using a conversion line shown in FIG. 15. In the graph shown in FIG. 15, the horizontal axis shows a logarithm of an output value of output image data, and the vertical axis shows a density corresponding to the output value. The slope of the conversion line is well known by the type of sensitive materials. Using this conversion line, the CPU 51 finds the output value SAi corresponding to the density data DAi and the average SAave of the output values corresponding to the average DAave of the density data and then calculates the light amount difference ΔEAi=log(SAi)−log(SAave) (step S206).

Incidentally, in place of using the previously prepared conversion line as in FIG. 15, the CPU 51 may determine, for example, a conversion line as shown in FIG. 16 by interpolating output values S₁, S₂, S₃ and S₄ obtained from the correction image having a plurality of different densities, and density data Dave₁, Dave₂, Dave₃ and Dave₄. The density characteristic of the sensitive materials changes depending on a state of preservation or development processing conditions and therefore, it is preferred that the CPU 51 determines the density characteristic at that time. In the above-described example, the CPU 51 determines one conversion line for the correction image by using an average of the density data of each density section. Further, the CPU 51 may determine a conversion line by using each of the density data of each density section in each individual PLZT element and may use the conversion line for the correction.

Further, the CPU 51 calculates the correction amount CAi=10^{(-ΔEAi) of individual PLZT element (step S207).}

By the above processing, the correction amount CAi for all the PLZT elements of the print head is calculated one by one. Each light emission amount correction coefficient is multiplied by each correction amount CAi to calculate a corrected light emission amount correction coefficient. When the apparatus 100 forms an image, the drive control unit 105 multiplies the image data and the corrected light emission amount correction coefficient and then outputs the product to the exposure head 42 to drive and control the exposure amount of each PLZT element.

According to the above-described apparatus 100 of the second embodiment, the same effects as listed in the apparatus 1 of the first embodiment are of course obtained. Further, the following effects can be obtained. That is, since the adjustment of the light emission amount correction coefficient is performed after variation in the drive history of each PLZT element, namely, variation in the record amount is suppressed by the first preliminary drive control member, the adjustment of the light emission amount correction coefficient can be performed using appropriate correction information suppressed in change of the image density affected by the drive history of the PLZT elements. As a result, overcorrection is prevented from being performed. Accordingly, the gradation change in the sub-scanning direction is suppressed so that an image with no density irregularities can be obtained.

Further, since the adjustment of the light emission amount correction coefficient is performed on the basis of the correction image recorded in the paper 3, the material characteristic of the paper 3 is reflected on the adjustment of the light emission amount correction coefficient. As a result, an image with no density irregularities can be more suitably and surely obtained.

Further, since the adjustment of the light emission amount correction coefficient is performed on the basis of the statistics value of the correction information, the adjustment can be more surely and stably performed as well as reduction in the calculation amount and shortening of the calculation time can be attained.

Further, since the adjustment of the light emission amount correction coefficient is performed by comparing the correction information of the different density information acquisition areas, the comparison not only in one area but also in a plurality of areas is enabled. As a result, accuracy in identification of the density irregularities due to factors other than the recording head can be improved as well as measurement errors in the acquisition of correction information can be reduced.

Further, since an image as the correction information is formed using a straight portion in the characteristic curve of the paper 3, namely, a portion where a change of the density relative to that of the logarithm of the record amount is constant, the change of the density relative to that of the record amount is noticeable. As a result, the difference in the density irregularities is made clearer so that the correction accuracy can be improved.

Further, since three primary colors of R, G and B can be individually controlled, a high image quality can be obtained.

Further, since the drive voltage where the light transmission amount of the PLZT element is maximized is applied, the drive voltage can be easily and simply controlled as well as the change of the light transmission amount relative to that of the drive voltage decreases and an allowance increases. As a result, the density change or the density irregularities can be suppressed.

Moreover, since the drive voltage corresponding to each of the light source colors can be set, light of three primary colors can be controlled by each corresponding voltage. As a result, the density change or density irregularity change can be reduced.

Incidentally, FIGS. 11 and 12 show examples of the gray color correction images. Further, a monochromatic correction image formed by color-developing each reference color in each area may be used. This monochromatic correction image may be recorded by only one reference color or by a plurality of reference colors.

Further, an image located in the leading portion of the density information acquisition area 118 is not necessarily a gray color image. The image recorded in the area may be, for example, a monochromatic image formed by color-developing only a cyan color component (Red exposure).

Further, also in the density information acquisition area 118, the image recorded in the area may be a monochromatic image similarly formed, for example, by color-developing only a yellow color component (Blue exposure).

Further, a daily change in the output adjustment of the image forming apparatus is caused by the recording head and the processor. The changes frequently appear as a sensitivity transfer when the characteristic curve moves in parallel. Accordingly, it is preferred to perform the following management of reflecting the EST value (EST: Exposure Standard Time) on the LUT using the LUT, in terms of reducing the daily changes.

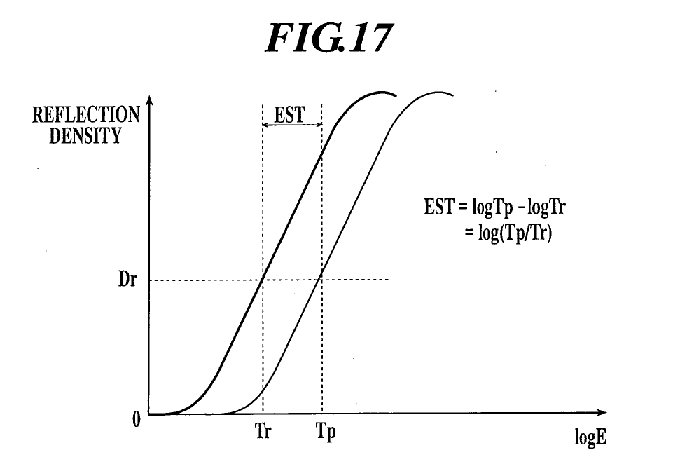

More specifically, it is preferred to perform the sensitivity movement of the output gradation characteristic by multiplying the reference output LUT by a constant in order to adjust the density of outputting an image of the reference image signal value to the reference density (Dr: e.g., 0.8) using reference recording materials, as shown in FIG. 17. The common logarithm of the constant at this time is expressed as an EST value.

When expressing the EST value as A, a final output LUT: L(i) relative to the reference output LUT: L₀(i) is preferably expressed by the following expression:
L (s) (i)=L₀ (s) (i)×10ˆ (A)

In the above expression, s represents a signal value of LUT and is 0 to 4095 in the case of 12 bit output system, and i represents a picture element number.

When adopting the above method, there can be realized conditions such that the sensitivity change scarcely has an effect on recording in the recording material. Incidentally, FIG. 17 is a diagram showing the sensitivity change. The vertical axis shows a reflection density and the horizontal axis shows a logarithm of the exposure amount. Further, Tp shows an exposure amount of the reference output LUT, and Tr shows the exposure amount where the reference density Dr and the print density agree.

Next, Examples of the above-described image forming apparatus according to the present invention are described with Comparative Examples.

### EXAMPLE 1

Through the exposure of the light source colors R, G and B, the preliminary light emission and the fine light emission are performed on the basis of the light emission duty (a ratio of ON time to OFF time) shown in Table 1. As a result, there is obtained a print comprising a leading portion as a non-exposure area and a central portion where a gray solid image is printed. The print is subjected to evaluation. The evaluation is performed according to the following standards.

A: No density irregularity, no displacement of the color balance and deterioration of white background are confirmed. An extremely high image quality is obtained.

B: The density irregularity, the displacement of the color balance and deterioration of white background are slightly confirmed; however, a high image quality is obtained.

C: The density irregularity, the displacement of the color balance and deterioration of white background are somewhat confirmed; however, a problem-free image quality is obtained.

D: The density irregularity, the displacement of the color balance and deterioration of white background are confirmed. Despite no problem, the image quality is not preferable.

E: The density irregularity, the displacement of the color balance and deterioration of white background are apparently confirmed. An extremely problematic image quality is obtained.

The results are shown in Table 1. In Table 1, “FIRST LIGHT EMISSION DUTY” means a light emission duty (namely, the light emission duty according to the preliminary light emission) of the PLZT element driven by the first preliminary drive member. “SECOND LIGHT EMISSION DUTY” means a light emission duty (namely, the light emission duty according to the fine light emission) of the PLZT element driven by the second preliminary drive member.

TABLE 1

| | | | SECOND LIGHT | |
|---|---|---|---|---|
| | | | EMISSION DUTY/ | PRINT VISUAL |
| | FIRST LIGHT | SECOND LIGHT | FIRST LIGHT | OBSERVATION |
| | EMISSION DUTY (%) | EMISSION DUTY (%) | EMISSION DUTY | RESULTS |
| EXAMPLE 1-1 | 10 | 2.0 | 20 | C |
| EXAMPLE 1-2 | 10 | 1.5 | 15 | B |
| EXAMPLE 1-3 | 10 | 1.0 | 10 | A |
| EXAMPLE 1-4 | 10 | 0.4 | 4 | A |
| EXAMPLE 1-5 | 10 | 0.3 | 3 | C |
| EXAMPLE 1-6 | 10 | 0.1 | 1 | C |
| EXAMPLE 1-7 | 10 | 2.5 | 25 | D |
| COMPARATIVE | 10 | 0.0 | 0 | E |
| EXAMPLE 1-1 | | | | |

From the print visual observation results in the Table 1, the following facts are found. When the light emission amount (the light emission amount of the fine light emission) of the PLZT elements driven by the second preliminary drive member is more than 20% of the light emission amount (the light emission amount of the preliminary light emission) of the PLZT elements driven by the first preliminary drive member, the density irregularity or displacement of the color balance is confirmed, and as a result, an unfavorable image quality is obtained. On the contrary, when it is less than 1%, deterioration of white background is apparently confirmed, and as a result, a problematic image quality is obtained.

### EXAMPLE 2

In performing the density adjustment (setup), the input signal value of each of the colors R, G and B is changed as shown in Table 2 to output a wedge-shaped chart. The chart is subjected to evaluation according to the standards of Example 1. The results are shown in Table 2.

TABLE 2

| | INPUT SIGNAL | PRINT VISUAL |
|---|---|---|
| | VALUE (S₀) | OBSERVATION RESULTS |
| EXAMPLE 2-1 | 140 | B |
| EXAMPLE 2-2 | 130 | A |
| EXAMPLE 2-3 | 80 | A |
| EXAMPLE 2-4 | 60 | B |
| EXAMPLE 2-5 | 150 | C |
| EXAMPLE 2-6 | 50 | C |

From the print visual observation results in Table 2, the following facts are found. When the input signal value (S₀) is in the range of 80≦S₀≦130, no density irregularity or no displacement of the color balance is confirmed, and an extremely high image quality is recorded.

Further, when the input signal value (S) is in the range of 60≦S₀≦140, the density irregularity or the displacement of the color balance is slightly confirmed; however a high image quality is recorded.

The entire disclosure of Japanese Patent Application No. 2004-217585 filed on Jul. 26, 2004, including specification, claims, drawings and summary are incorporated herein by reference in its entirety.

What is claimed is:

1. An image forming apparatus comprising a recording head constituted by arraying a plurality of recording elements, in which relative movement is caused between the recording head and a recording material to perform recording in the recording material, the apparatus comprising:
a first drive control member which drives the recording elements before recording in the recording material is started, and
a second drive control member which drives the recording elements, on the basis of an output signal value obtained by converting an input signal value, in order to perform recording in the recording material,
wherein the second drive control member drives the recording elements such that recording in a predetermined low record amount is performed in a predetermined low record amount area.

2. The apparatus of claim 1, wherein the second drive control member converts the input signal value to the output signal value by using a lookup table where the input signal value and output signal value are correlated with each other, and drives the recording elements.

3. The apparatus of claim 1, wherein the predetermined low record amount area is an area comprising an input signal value S set on the basis of an input signal value S₀ capable of obtaining a reference density, the input signal value S satisfying an expression of log(S/S₀)≦−1.0 in a characteristic curve of the recording material.

4. The apparatus of claim 1, wherein the second drive control member controls drive of the recording elements such that the predetermined low record amount is a constant value in the predetermined low record amount area.

5. The apparatus of claim 2, wherein the second drive control member controls drive of the recording elements such that the predetermined low record amount is a constant value in the predetermined low record amount area.

6. The apparatus of claim 3, wherein the second drive control member controls drive of the recording elements such that the predetermined low record amount is a constant value in the predetermined low record amount area.

7. The apparatus of claim 1, wherein the second drive control member drives the recording elements such that the recording in the predetermined low record amount is always performed in the predetermined low record amount area, when the recording element drives during an image formation.

8. The apparatus of claim 2, wherein the second drive control member drives the recording elements such that the recording in the predetermined low record amount is always performed in the predetermined low record amount area, when the recording element drives during an image formation.

9. The apparatus of claim 3, wherein the second drive control member drives the recording elements such that the recording in the predetermined low record amount is always performed in the predetermined low record amount area, when the recording element drives during an image formation.
